(19) United States
(12) Patent Application Publication
(10) Pub. No.: US 2010/0009560 A1
(43) Pub. Date: Jan. 14, 2010

(54) STORAGE DEVICE

(76) Inventor: Kab Qyu YOUN, Chungju-si (KR)

Correspondence Address: KED & ASSOCIATES, LLP, P.O. Box 221200, Chantilly, VA, 20153-1200, US

(21) Appl. No.: 12/341,386

(22) Filed: Dec. 22, 2008

(30) Foreign Application Priority Data
Jul. 9, 2008 (KR) 10-2008-0066679

(51) Int. Cl. H01R 13/60

(52) U.S. Cl. 439/131

(57) ABSTRACT

A storage device is provided. The storage device includes a case; a connector arranged in the case so to be able to be slidingly moved; a printed circuit board (PCB) and a memory disposed in the case; and a flexible film arranged between the connector and the PCB to connect the connector to the PCB, wherein the flexible film includes a dielectric film and a metal layer disposed on the dielectric film. Thus, it is possible to easily accommodate the connector in the case and to properly protect the connector.

### CROSS-REFERENCE TO RELATED APPLICATION

This application claims priority from Korean Patent Application No. 10-2008-0066679 filed on Jul. 9, 2008 in the Korean Intellectual Property Office, the disclosure of which is incorporated herein by reference in its entirety.

### BACKGROUND OF THE INVENTION

1. Field of the Invention

The present invention relates to a storage device, and more particularly, to a storage device in which a connector can be slidingly moved and easily accommodated in a case by connecting the connection terminal and a printed circuit board (PCB) via a flexible film.

2. Description of the Related Art

As the market for small digital devices grows rapidly, various efforts have been made to miniaturize and sophisticate the core elements of small digital devices. As the size of integrated circuit (IC) elements for small digital devices decreases, the size of circuit boards for installing IC elements has gradually decreased, and thus, the integration density of IC elements has gradually increased.

In the meantime, storage devices compress and store various data as image data with the use of connectors that support serial-, parallel- and universal serial bus (USB)-interfaces, decompress the image data, and provide the decompressed image data to a host system, thereby enabling the storage and the transfer of large amounts of data storage devices, in particular, are generally small in size and are formed as thin cards. Thus, storage devices are easy to carry and use and are thus being widely used in various devices such as a host system, a personal computer (PC), a laptop computer, an MP3 player, and a digital camera for backing up data. The range of application of storage devices is expected to widen further storage devices can provide a very simple and easy method for transmitting data with the use of connectors.

### SUMMARY OF THE INVENTION

The present invention provides a storage device in which a connector can be slidingly moved and easily accommodated in a case by connecting the connection terminal and a printed circuit board (PCB) via a flexible film.

According to an aspect of the present invention, there is provided a storage device including a case; a connector arranged in the case so to be able to be slidingly moved; a printed circuit board (PCB) and a memory disposed in the case; and a flexible film arranged between the connector and the PCB to connect the connector to the PCB, wherein the flexible film includes a dielectric film and a metal layer disposed on the dielectric film.

### BRIEF DESCRIPTION OF THE DRAWINGS

The above and other features and advantages of the present invention will become more apparent by describing in detail preferred embodiments thereof with reference to the attached drawings in which:

FIGS. 1 and 2 illustrate perspective views of a storage device according to an exemplary embodiment of the present invention;

FIG. 3 illustrates a cross-sectional view of the storage device shown in FIG. 1;

FIGS. 4 and 5 illustrate cross-sectional views of examples of a flexible film included in the storage device shown in FIG. 1;

FIGS. 6A through 7B illustrate cross-sectional views of storage devices according to other exemplary embodiments of the present invention; and

FIG. 8 illustrates a cross-sectional view of a storage device according to another exemplary embodiment of the present invention.

### DETAILED DESCRIPTION OF THE INVENTION

The present invention will hereinafter be described in detail with reference to the accompanying drawings in which exemplary embodiments of the invention are shown.

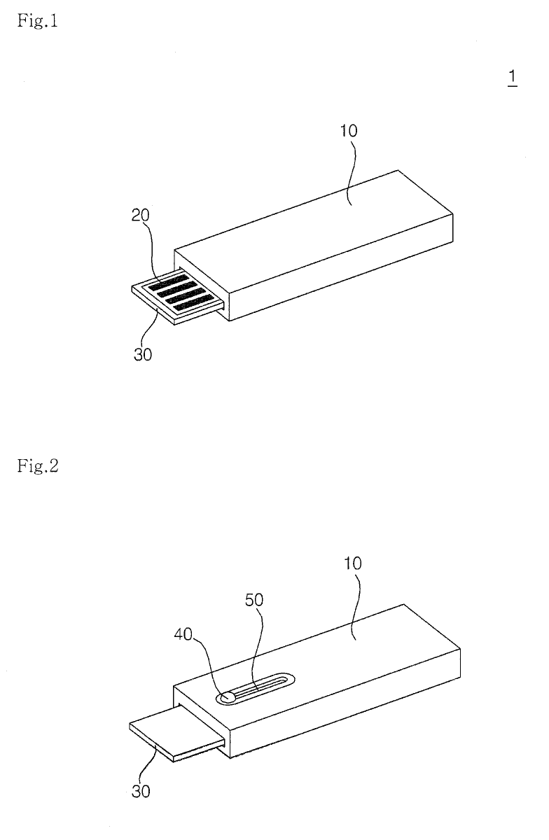

FIGS. 1 and 2 illustrate perspective views of a storage device according to an exemplary embodiment of the present invention. Referring to FIGS. 1 and 2, a storage device 1 may include a case 10, a connector 20, a printed circuit board (PCB, not shown), a flexible film (not shown), a guide 30 and a lever 40.

The case 10 may accommodate the connector 20 and the PCB therein and may thus protect the connector 20 and the PCB.

The connector 20 may include the guide 30. The guide 30 may allow the connector 20 to be slidingly moved in and out of the case 10 when the connector 20 is coupled to the case 10. The guide 30 may include the lever 40 applying external force for allowing the connector 20 to be slidingly moved in and out of the case 10.

Referring to FIG. 2, a groove 50 may be formed on the bottom surface of the case 10. The lever 40, which applies external force to the connector 20 so as to allow the connector 20 to be slidingly moved, may be moved along the groove 50.

The groove 50 is illustrated in FIG. 2 as being formed on the bottom surface of the case 10 of the storage device 1, but the present invention is not restricted to this. That is, the groove 50 may be formed on any one of the surfaces of the case 10, e.g., the top surface or a side surface of the case 10.

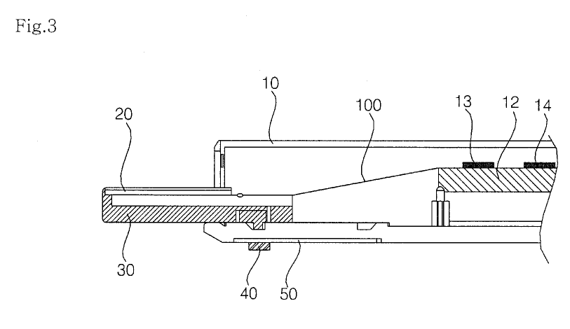

FIG. 3 illustrates a cross-sectional view of the storage device 1. Referring to FIG. 3, the connector 20 may be ejected from the case 10. The PCB 12 may be disposed in the case 10, and the connector 20 may be connected to the PCB 12 via a flexible film 100. Thus, the connector 20 and the PCB 12 may transmit data to or receive data from each other. The PCB 12 may include a memory 13 storing data and a controller 14. The memory 13 and the controller 14 may be disposed on the PCB 12 and may be electrically connected to each other.

In order to eject the connector 20 from the case 10, the guide 30 may be slidingly moved by applying external force with the use of the lever 40. In this case, the lever 40 may be moved along the groove 50.

When the connector 20 is ejected from the case 10, the flexible film 100 may be unfolded and may thus be flat, as shown in FIG. 3.

On the other hand, when the connector 20 is inserted in the case 10, the flexible film 100 may be folded into a certain shape. The flexible film 100 must be flexible so as not to be broken even after a long use of the storage device 1.

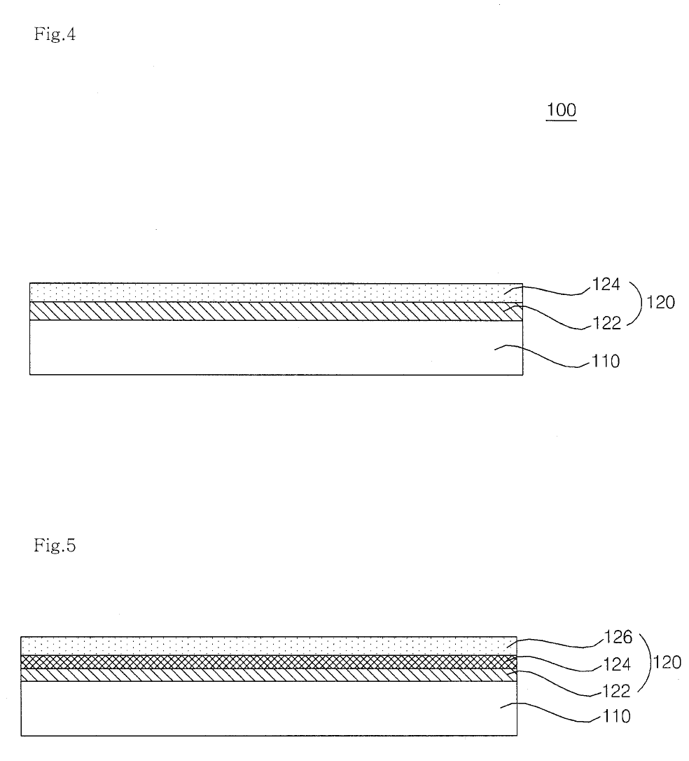

FIGS. 4 and 5 illustrate cross-sectional views of examples of the flexible film 100. The flexible film 100 may be formed by forming a metal layer on a dielectric film and printing a circuit pattern on the metal layer. The flexible film 100 may connect the connector 20 and the PCB 12.

More specifically, referring to FIG. 4, the flexible film 100 may include a dielectric film 110 and a metal layer 120 formed on the dielectric film 110. The metal layer 120 may include a first metal layer 122 formed on the dielectric film 110 and a second metal layer 124 formed on the first metal layer 122.

The dielectric film 110 may contain a polymer material such as polyimide, polyester, or liquid crystal polymer.

The top surface of the dielectric film 110 may be appropriately treated in order to enhance the peel strength between the dielectric film 110 and the metal layer 120.

The top surface of the dielectric film 110 may be treated using plasma or ion beams or using an alkali etching method.

Table 1 shows the relationship among the haze of the dielectric film 110, the peel strength between the dielectric film 110 and the metal layer 120 and the efficiency of testing a circuit pattern formed on the metal layer 120.

TABLE 1

| Haze | Peel Strength | Efficiency of Testing Circuit Pattern |
|---|---|---|
| 1% | X | ◯ |
| 2% | ◯ | ◯ |
| 5% | ◯ | ◯ |
| 10% | ◯ | ◯ |
| 15% | ◯ | ◯ |
| 20% | ◯ | ◯ |
| 25% | ◯ | ◯ |
| 27% | ◯ | X |
| 30% | ◯ | X |

Referring to Table 1, the top surface of the dielectric film 110 may be treated so as for the dielectric film 110 to have a haze of about 2-25%. If the haze of the dielectric film 110 is lower than 2%, defects may be insufficiently generated on the dielectric film 110, and thus, the peel strength between the dielectric film 110 and the metal layer 120 may decrease. On the other hand, if the haze of the dielectric film 110 is higher than 25%, the peel strength between the dielectric film 110 and the metal layer 120 may increase. However, the transmittance of the dielectric film 110 may decrease, and thus, the efficiency of testing the circuit pattern on the metal layer 120 may decrease.

The metal layer 120 may contain nickel (Ni), gold (Au), chromium (Cr), or copper (Cu). The metal layer 120 may include the first metal layer 122 and the second metal layer 124 disposed on the first metal layer 122.

The first metal layer, which is a seed layer of the metal layer 120, may be formed using an electroless plating method. The first metal layer 122 may contain nickel, copper, gold or chromium. In order to enhance the efficiency of electroplating for forming the second metal layer 124, the first meal layer 122 may be formed of nickel or copper having a low resistance.

The electroless plating method is a type of plating method involving extracting metal ions in a plating solution through a chemical reaction induced by a reducing agent. Examples of the electroless plating method include a replacement plating method and a chemical reduction plating method.

The composition of an electroless plating solution used for forming the first metal layer 122 may vary according to the type of metal used for forming the first metal layer 122. For example, the electroless plating solution may contain a copper sulphate aqueous solution. The thickness of the first metal layer 122 may be determined by the duration for which the dielectric film 110 is immersed in the electroless plating solution and the concentration of the electroless plating solution.

The second metal layer 124 may be formed on the first metal layer 122 through electroplating. The second metal layer 124 may be formed of gold or copper. For example, the second metal layer 124 may be formed by immersing the dielectric film 110 on which the first metal layer 122 is formed in an electroplating solution containing a copper sulphate aqueous solution and applying a current so as to extract copper ions in the electroplating solution as copper. The thickness of the second metal layer 124 may be determined by the magnitude of the current and the concentration of the electroplating solution.

Table 2 shows the relationship among the ratio of the thickness of the metal layer 120 to the thickness of the dielectric film 110, the flexibility of the flexible film 100 and the peel strength between the dielectric film 110 and the metal layer 120 when the dielectric film 110 has a thickness of 38 μm.

TABLE 2

| Ratio of Thickness of Metal Layer to | | |
|---|---|---|
| Thickness of Dielectric Film | Flexibility | Peel Strength |
| 1:1.4 | X | ◯ |
| 1:1.5 | ◯ | ◯ |
| 1:2 | ◯ | ◯ |
| 1:4 | ◯ | ◯ |
| 1:6 | ◯ | ◯ |
| 1:8 | ◯ | ◯ |
| 1:10 | ◯ | ◯ |
| 1:11 | ◯ | X |

Referring to Table 2, electroless plating for forming the first metal layer 122 and electroplating for forming the second metal layer 124 may be performed so that the ratio of the thickness of the metal layer 120 to the thickness of the dielectric film 110 can become about 1:1.5 to about 1:10.

If the thickness of the metal layer 120 is less than 1/10 of the thickness of the dielectric film 110, the peel strength between the dielectric film 110 and the metal layer 120 may considerably decrease. Thus, the metal layer 120 may be easily detached from the dielectric film 110, or the dimensional stability of the circuit pattern on the metal layer 120 may deteriorate.

On the other hand, if the thickness of the metal layer 120 is greater than ⅔ of the thickness of the dielectric film 110, the flexibility of the flexible film 100 may deteriorate, or the probability of the metal layer 120 being damaged by minor components in a plating solution may increase due to a prolonged plating operation.

Table 3 shows the relationship among the ratio of the thickness of the first metal layer 122 to the thickness of the second metal layer 124, the stability of the metal layer 120 and the peel strength between the dielectric film 110 and the metal layer 120.

TABLE 3

| Ratio of Thickness | | |
|---|---|---|
| of First Metal Layer to | | |
| Thickness of Second Metal Layer | Stability | Peel Strength |
| 1:4 | ◯ | X |
| 1:5 | ◯ | ◯ |
| 1:10 | ◯ | ◯ |
| 1:100 | ◯ | ◯ |
| 1:200 | ◯ | ◯ |
| 1:300 | ◯ | ◯ |
| 1:400 | ◯ | ◯ |
| 1:450 | ◯ | ◯ |
| 1:500 | ◯ | ◯ |
| 1:520 | X | ◯ |

Referring to Table 3, the ratio of the thickness of the first metal layer 122 to the thickness of the second metal layer 124 may be about 1:5 to about 1:500. If the thickness of the first metal layer 122 is greater than ⅕ of the thickness of the second metal layer 124, the peel strength between the first metal layer 122 and the dielectric film 110 may deteriorate due to a prolonged electroless plating operation for forming the first metal layer 122, and particularly, due to minor components in an electroless plating solution for forming the first metal layer 122.

On the other hand, if the thickness of the first metal layer 122 is less than 1/500 of the thickness of the second metal layer 124, the first metal layer 122 may be replaced with stannum (Sn) during the formation of a stannum layer on the circuit pattern on the second metal layer 124.

The metal layer 120 may have a triple-layer structure, as shown in FIG. 5. In this case, the metal layer 120 may be formed on the dielectric film 110 through sputtering or plating. More specifically, referring to FIG. 5, the metal layer 120 may include a first metal layer 122, a second metal layer 124 and a third metal layer 126. The first and second metal layers 122 and 124 may be formed through sputtering, and the third metal layer 126 may be formed through electroplating.

The first metal layer, which is a seed layer of the metal layer 120, may contain nickel, copper, gold, and/or chromium. For example, the first metal layer 120 may be formed of an alloy of nickel and chromium. More specifically, the first metal layer 122 may contain an alloy of 97% nickel and 3% chromium or an alloy of 93% nickel and 7% nickel. If the first metal layer 122 is formed of an alloy of nickel and chromium, the heat resistance of the dielectric film 110 may increase.

The second metal layer 124 may be formed on the first metal layer 122 through sputtering. The second metal layer 124 may be formed of copper in order to improve the efficiency of electroplating for forming the third metal layer 126. More specifically, if the second metal layer 124 is formed of such a highly-conductive metal as copper, the resistance of the second metal layer 124 may decrease, thereby facilitating electroplating for forming the third metal layer 126.

Table 4 shows the relationship among the ratio of the sum of the thicknesses of the first and second metal layers 122 and 124 to the thickness of the third metal layer 126, the efficiency of electroplating for forming the third metal layer 126 and the peel strength of the third metal layer 126 when the third metal layer 126 has a thickness of 9 μm.

TABLE 4

| Ratio of Sum of Thicknesses of First | | |
|---|---|---|
| and Second Metal Layers to Thickness | | |
| of Third Metal Layer | Plating Efficiency | Peel Strength |
| 1:10 | X | ◯ |
| 1:12 | ◯ | ◯ |
| 1:15 | ◯ | ◯ |
| 1:20 | ◯ | ◯ |
| 1:40 | ◯ | ◯ |
| 1:60 | ◯ | ◯ |
| 1:80 | ◯ | ◯ |
| 1:100 | ◯ | ◯ |
| 1:120 | ◯ | ◯ |
| 1:180 | ◯ | ◯ |
| 1:200 | ◯ | ◯ |
| 1:250 | ◯ | ◯ |
| 1:300 | ◯ | ◯ |
| 1:350 | ◯ | ◯ |
| 1:400 | ◯ | ◯ |
| 1:450 | ◯ | ◯ |
| 1:500 | ◯ | ◯ |
| 1:520 | ◯ | X |
| 1:530 | ◯ | X |

Referring to Table 4, the ratio of the sum of the thicknesses of the first and second metal layers 122 and 124 to the thickness of the third metal layer 126 may be about 1:12 to about 1:500. If the ratio of the sum of the thicknesses of the first and second metal layers 122 and 124 to the thickness of the third metal layer 126 is greater than 1:500, the peel strength of the third metal layer 126 may decrease, and the heat resistance of the flexible film 100 may deteriorate. On the other hand, if the ratio of the sum of the thicknesses of the first and second metal layers 122 and 124 to the thickness of the third metal layer 126 is less than 1: 12, the resistance of the second metal layer 124 may increase, and thus, the efficiency of electroplating for forming the third metal layer 126 may decrease.

The flexible film 100 is illustrated in FIGS. 4 and 5 as having only one metal layer formed on the top surface of the dielectric film 110, but the present invention is not restricted to this. That is, the flexible film 100 may include two metal layers 120 formed on the top surface and the bottom surface, respectively, of the dielectric film 110.

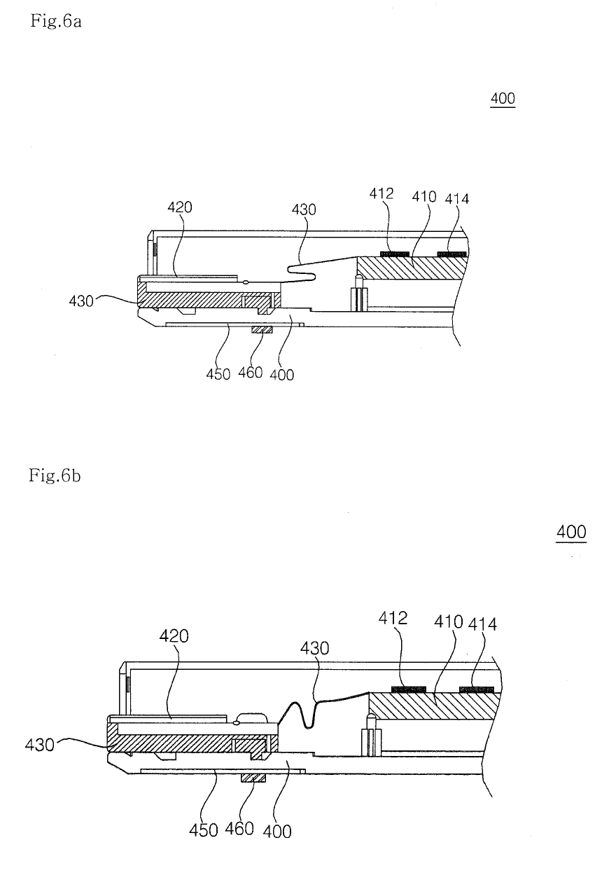

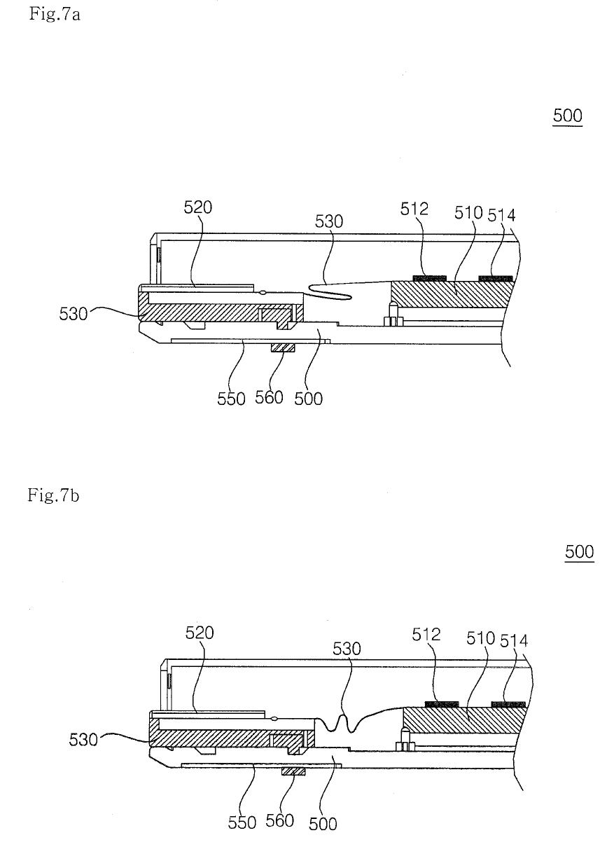

FIGS. 6A through 7B illustrate cross-sectional views of storage devices according to other exemplary embodiments of the present invention. More specifically, FIGS. 6A through 7B illustrate the case in which a connector of a storage device is inserted in a case of the storage device.

Referring to FIGS. 6A and 6B, a PCB 410 and a connector 420 may both be disposed in a case 400 so as to have different heights. Referring to FIGS. 7A and 7B, a PCB 510 and a connector 520 may both be disposed in a case 500 so as to have the same height.

Referring to FIG. 6A, when the connector 420 is inserted into the case 400, a flexible film 440 may be folded in a direction parallel to a direction in which the connector 420 is slidingly moved. The flexible film 440 is illustrated in FIG. 6A as being folded twice, but the present invention is not restricted to this. That is, the flexible film 440 may be folded more twice.

Referring to FIG. 6B, the flexible film 440 may be folded in a direction perpendicular to the direction in which the connector 420 is slidingly moved. The flexible film 440 is illustrated in FIG. 6B as being folded more than once into a ripple-like shape, but the present invention is not restricted to this. That is, the flexible film 440 may be folded once into the shape of an arc.

Referring to FIGS. 7A and 7B, the connector 520 and the PCB 510 may have the same height. In this case, a flexible film 540, like the flexible film 440 of FIG. 6A or 6B, may be folded in a direction parallel or perpendicular to a direction in which the connector 520 is slidingly moved.

In short, it is possible to uniformly maintain the flexibility of the flexible film 540 and prevent the flexible film 540 from being broken due to being repeatedly folded and unfolded by forming a metal layer on a dielectric film while uniformly maintaining the ratio of the thicknesses of the dielectric layer and the metal layer.

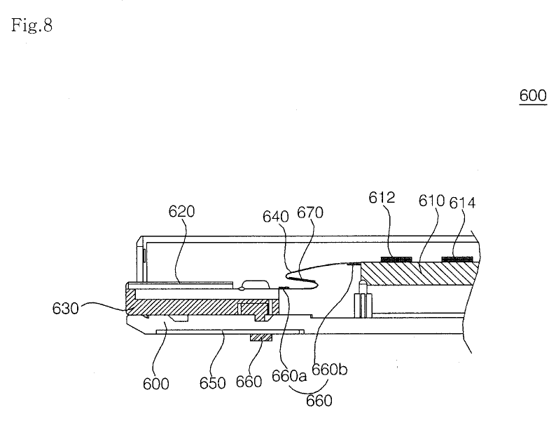

FIG. 8 illustrates a cross-sectional view of a storage device according to another exemplary embodiment of the present invention. Referring to FIG. 6, in order to properly fold up a flexible film 640 in a case 600 when a connector 620 is inserted in the case 600, a plurality of reinforcement plates, i.e., a pair of end reinforcement plates 660 and a middle reinforcement plate 670, may be formed.

More specifically, the end reinforcement plates 660 may be formed on either end portion of the flexible film 640, to which a PCB 610 and the connector 620 are connected.

The end reinforcement plates 660 may reinforce either end of the flexible film 640. The end reinforcement plates 660 may prevent the flexible film 640 from being damaged by the load caused by the connector 620 when the connector 620 is slidingly moved in a horizontal direction. The middle reinforcement plate 670 may be installed in the middle of the flexible film 640. The middle reinforcement plate 670 may enable the flexible film 640 to be folded into a certain shape when the connector 620 is inserted in the case 600 and may thus prevent the flexible film 640 from being damaged by being severely folded.

In short, the PCB 610 and the connector 620 may be connected via the flexible film 640, and the flexible film 640 may be folded into a certain shape when the connector 620 is inserted in the case 600. Therefore, it is possible to easily accommodate the connector 620 in the case 600 and to properly protect the connector 620.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A storage device comprising:
a case;
a connector arranged in the case so to be able to be slidingly moved;
a printed circuit board (PCB) and a memory disposed in the case; and
a flexible film arranged between the connector and the PCB to connect the connector to the PCB,
wherein the flexible film includes a dielectric film and a metal layer disposed on the dielectric film.

2. The storage device of claim 1, wherein the ratio of the thickness of the metal layer to the thickness of the dielectric film is approximately 1:1.5 to approximately 1:10.

3. The storage device of claim 1, wherein the metal layer includes a first metal layer electroless-plated on the dielectric film and a second metal layer electro-plated on the first metal layer and the ratio of the thickness of the first metal layer to the thickness of the second metal layer is approximately 1:5 to approximately 1:500.

4. The storage device of claim 1, wherein the metal layer includes a first metal layer disposed on the dielectric film, a second metal layer disposed on the first metal layer, and a third metal layer disposed on the second metal layer.

5. The storage device of claim 4, wherein the first and second metal layers are formed using sputtering and the third metal layer is formed using electroplating.

6. The storage device of claim 4, wherein the ratio of the sum of the thicknesses of the first and second metal layers to the thickness of the third metal layer is 1:12 to 1:500.

7. The storage device of claim 1, wherein the haze of the dielectric film is approximately 2% to approximately 25%.

8. The storage device of claim 1, wherein the metal layer includes a circuit pattern.

9. The storage device of claim 1, wherein the dielectric film includes at least one of polyimide, liquid crystal polymer, and polyester.

10. The storage device of claim 1, wherein the metal layer includes at least one of nickel (Ni), gold (Au), chrome (Cr), and copper (Cu).

11. The storage device of claim 1, wherein a portion of the flexible film is folded in a direction substantially parallel to a direction in which the connector is moved in and out of the case.

12. The storage device of claim 1, wherein a portion of the flexible film is folded in a direction substantially perpendicular to a direction in which the connector is moved in and out of the case.

13. The storage device of claim 1, wherein the connector and the PCB are arranged to have substantially the same height.

14. The storage device of claim 1, wherein the connector and the PCB are arranged to have different heights.

15. The storage device of claim 1, further comprising a lever enabling the connector to be slidingly moved in and out of the case.

16. The storage device of claim 15, wherein the case has a groove formed on a surface of the case and the lever protrudes beyond the surface of the case through the groove and can be moved along the groove.
